(19) United States
(12) Patent Application Publication
(10) Pub. No.: US 2024/0318998 A1
(43) Pub. Date: Sep. 26, 2024

(54) METHOD FOR OPERATING A CORIOLIS MEASUREMENT DEVICE

(71) Applicant: Endress+Hauser Flowtec AG, Reinach (CH)

(72) Inventors: Hao Zhu, Freising (DE); Gerhard Eckert, Grenzach-Wyhlen (DE)

(21) Appl. No.: 18/575,383

(22) PCT Filed: Jun. 28, 2022
(86) PCT No.: PCT/EP2022/067719

§ 371 Date: Dec. 29, 2023

(30) Foreign Application Priority Data
Jul. 1, 2021 (DE) 10 2021 117 028.1

(51) Int. Cl. G01F 25/10; G01F 1/84

(52) U.S. Cl. CPC G01F 25/10; G01F 1/8422; G01F 1/8477

(57) ABSTRACT

A method for operating a Coriolis measurement device is provided. The Coriolis measurement device comprises at least one measuring tube for conducting a medium, at least one exciter for exciting measuring tube oscillations, at least one first sensor and at least one second sensor for detecting measuring tube oscillations, an electronic measuring/operating circuit for operating the exciter and for detecting and evaluating measuring signals of the sensors. The method comprises the following steps: checking, in a first method step, whether one of the following variables of the medium: flow velocity or mass flow, exceeds a first threshold value and/or whether a variation of a measuring signal from an average value exceeds a second threshold value, and in a second method step, if the first threshold value and/or the second threshold value is exceeded, increasing an oscillation amplitude of the measuring tube oscillations by a factor E by boosting exciter performance.

The invention relates to a method for operating a Coriolis measurement device for measuring a mass flow and/or a density of a medium flowing through a tube.

Coriolis measurement devices, as shown for example in DE102017125273A1, are usually calibrated prior to an initial startup, wherein the Coriolis measurement device is subjected to a precisely measured mass flow in order to match it with measurement signals from sensors for detecting measuring tube oscillations.

From time to time, customers need to check whether the Coriolis measurement device is still well calibrated at a current point in time or whether there is a need for recalibration. However, due to time constraints, the Coriolis measurement device is often subjected to large mass flow rates in order to quickly complete the check/recalibration. However, this results in degraded measurement signal quality at the Coriolis measurement device due to increased signal noise, which can cause the Coriolis measurement device to be insufficiently checked/calibrated.

It is therefore the object of the invention to propose a method that ensures a correct checking result or a correct calibration.

The object is achieved by a method according to independent claim 1.

With a method according to the invention for recognizing a calibration and operating a calibration mode of a Coriolis measurement device for measuring a mass flow and/or a density of a medium flowing through a tube,
wherein the Coriolis measurement device comprises:
at least one measuring tube for conducting a medium,
at least one exciter for generating measuring tube oscillations,
at least one first sensor and in particular at least one second sensor for detecting measuring tube oscillations,
an electronic measuring/operating circuit for operating the exciter and for detecting and evaluating measurement signals from the sensors and for providing measured values of the mass flow and/or density,
wherein the method includes the following steps:

In a first method step, checking whether an amount of a measured value of at least one test variable exceeds a first threshold value or a variation of measured values of a test variable exceeds a second threshold value,
and increasing a oscillation amplitude of the measuring tube oscillations by a factor E by boosting exciter performance in a second method step when a threshold value is exceeded, wherein the test variable is based on the following variable:
flow velocity,
wherein the following applies for G1:
the flow velocity in the measuring tube greater than 4 m/s, in particular greater than 4.5 m/s, preferably greater than 5 m/s,
wherein the following applies for G2:
the variation of flow velocity in the measuring tube is
in a time interval of at least 0.5 seconds, in particular at least 1 second, preferably at least 2 seconds
greater than 150%, in particular greater than 175% and preferably greater than 200% of a reference value.

The variation of measured values of the measurement variable can be determined, for example, by summing distances of adjacent measured values over a time interval. However, it is also possible to determine a standard deviation over a time interval, for example. The second threshold value or reference value can, for example, be derived from experience and/or determined by a calibration, for example, upon the first-time startup of the Coriolis measurement device.

In one embodiment, E is at least 1.1, and preferably at least 1.3 and in particular at least 1.5 and/or wherein E is at most 4, and preferably at most 3 and in particular at most 2.5.

In this way, a signal-to-noise ratio can be significantly improved, such that a calibration is performed cleanly and robustly. A measuring tube overload can be prevented by setting up a maximum value.

In one embodiment, a time period or a number of measuring tube oscillations of one cycle of an increase in oscillation amplitude is limited.

In this way, overload failure of the at least one measuring tube can be avoided. Typically, checking scenarios or test scenarios last only a short time, such that a single check typically takes less time than a limitation B on the time period or number of measuring tube oscillations allows. Exhausting the limitation does not lead to measuring tube failure. In this case, the person skilled in the art refers, for example, to literature in which a correlation between material stress and material fatigue is indicated. The person skilled in the art will find such information for example in ASME, Section VIII, Div. 2, Code Edition 2001, see for example Curve 110.2.1.

The measuring tube is preferably made of an alloy steel, in particular a high-alloy steel.

In one embodiment, an overload is calculated based on a total time of increase in oscillation amplitude or a number of measuring tube oscillations with increased oscillation amplitude over all cycles and based on the respective increase.

The calculation of the overload can also be based on the correlation specified above.

In one embodiment, if the overload exceeds a threshold value, a warning message is output.

In one embodiment, the increase in the oscillation amplitude is terminated upon the value falling below of the first threshold value and/or a third threshold value concerning the variation of the measurement variable.

The third threshold value can be determined similarly to the second threshold value. Upon the value falling below of a minimum variation, there may be a reason to reduce the signal amplitude back to a normal value.

In one embodiment, the factor E is dependent on a measure of the exceeding of the first threshold value and/or second threshold value.

In this way, an increase that is too small along with excessive stress on the measuring tube can be prevented.

In one embodiment, the exciter along with the sensors in each case have a coil device having at least one coil and in each case a magnetic device having at least one magnet. The excitation of measuring tube oscillations is based on the generation of electromagnetic repulsive forces between the coil and the magnet by an alternating electric current flowing through the coil. An increase in an amplitude of the alternating current results in an increase in the oscillation amplitude.

Conversely, the sensors use electromagnetic induction of a voltage and thus a current in the coil to detect oscillations in the measuring tube.

In one embodiment, the reference value is stored in the electronic measuring/operating circuit and is determined, for example, by a calibration upon the first-time startup of the Coriolis measurement device.

The invention will now be described with reference to exemplary embodiments.

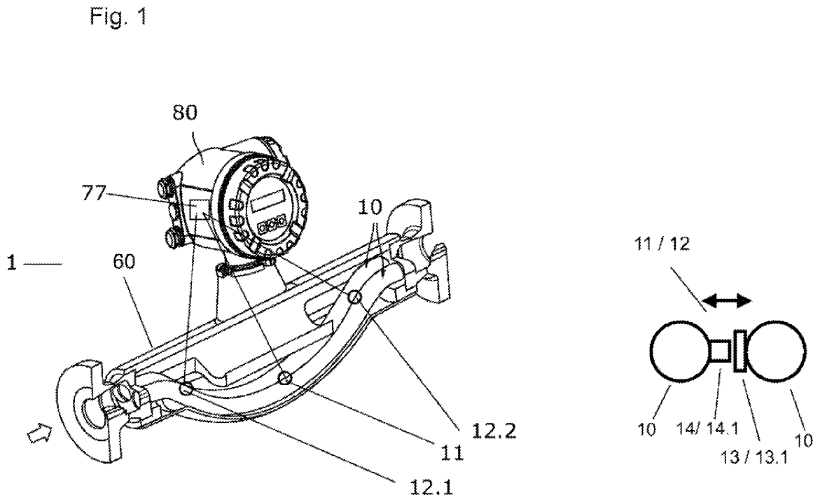

FIG. 1 describes an exemplary Coriolis measurement device;

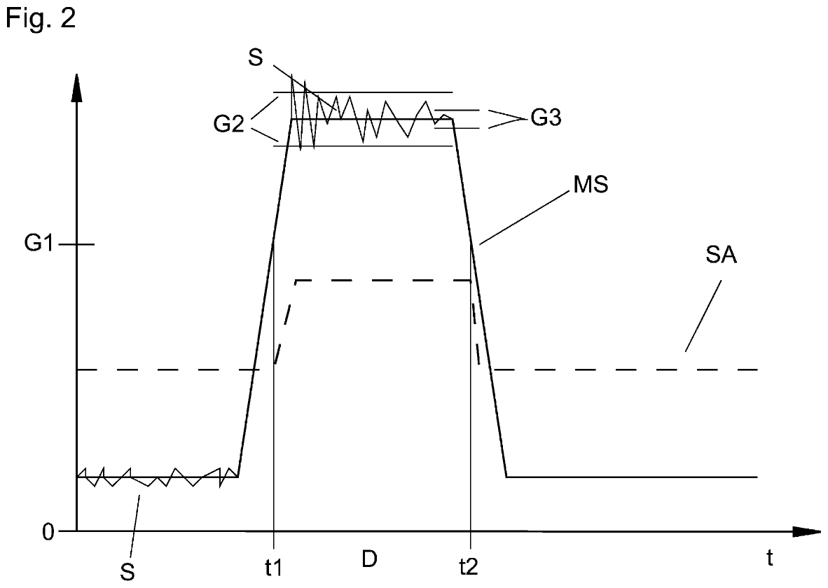

FIG. 2 shows exemplary schematic curves of a measurement variable and a signal amplitude;

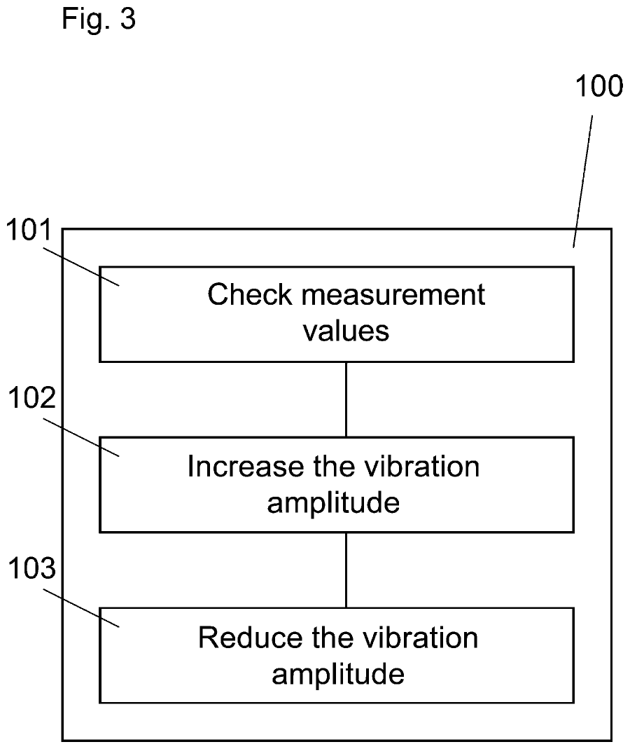

FIG. 3 illustrates the sequence of a method according to the invention;

FIG. 1 shows an exemplary Coriolis measurement device 1 for measuring a mass flow or a density of a medium flowing through a pipeline, comprising two measuring tubes 10, each having an inlet 10.1 and an outlet 10.2, wherein a measuring tube wall 10.4 encloses a measuring tube lumen 10.3. The measuring tubes are excited to vibrate by an exciter 11; a first sensor 12.1 on the inlet side and a second sensor 12.2 on the outlet side detect the measuring tube oscillations and generate measurement signals, which are evaluated by an electronic measuring/operating circuit 77 arranged in a housing 80. The measuring tubes are held by a supporting element. As shown here, the sensor and the exciter can each have a coil device 13 with a coil 13.1 and a magnetic device 14 with a magnet 14.1, wherein the coil device and the magnetic device experience relative movements as a result of measuring tube oscillations. As a result of the relative movement, electrical voltages are induced in the coil, and electrical currents are thus caused, which are processed by the electronic measuring/operating circuit. The measurement signal can be the electrical voltage or the electrical current. Since inaccuracies in production and manufacturing exist also in Coriolis measurement devices, different sensors are not exactly the same, and therefore they produce slightly different measurement signals under the same conditions, which manifests, for example, in different amplitudes of measurement signals. This asymmetry between the sensors can be used as a further measurement variable in order to be able to detect, for example, an operating state or a wear state of the Coriolis measurement device.

Coriolis measurement devices can also have only one measuring tube or more than two measuring tubes. A person skilled in the art will then adapt the exciter and the sensors accordingly. Thus, it is not necessary for the coil device and the magnetic device to each be arranged on one measuring tube, but they can, for example, also be fastened to the supporting element via a holding device. Coriolis measurement devices can also have more than one exciter and/or more than two sensors.

FIG. 2 sketches an exemplary schematic curve of measured values MS of a test variable such as flow velocity, mass flow, volume flow, along with the exemplary schematic curve of an oscillation amplitude SA. The measured value curve exceeds a first threshold value G1 at a point in time t1 and falls below such first threshold value at a point in time t2. As indicated, such exceeding of the threshold value can lead to an increased measured value variation S around an average value of the measurement variable, which exceeds a second threshold value in the time interval t1-t2 corresponding to the time period D. The exceeding of the first threshold value G1 and/or the exceeding of the second threshold value G2 is taken as a reason to increase the signal amplitude SA by a factor E, such that the variation falls below the threshold value G2. In this case, the average value can be a moving average.

In this case, G1 is characterized as follows: The flow velocity in the measuring tube is greater than 4 m/s, in particular greater than 4.5 m/s, preferably greater than 5 m/s.

G2 is characterized as follows: The variation of flow velocity in the measuring tube or mass flow or volume flow is greater than 150%, in particular greater than 175% and preferably greater than 200% of a reference value in a time interval of at least 0.5 seconds, in particular at least 1 second, preferably at least 2 seconds.

In one embodiment, E is at least 1.1, and preferably at least 1.3 and in particular at least 1.5, wherein E is at most 4, and preferably at most 3 and in particular at most 2.5.

The variation of the measured values can be determined, for example, by summing the distances of adjacent measured values over a time interval. However, it is also possible to determine a standard deviation over a time interval, for example. The second threshold value can be derived, for example, from experience or from physical equations describing a flow of the medium in the measuring tube. For example, it can also be determined from a calibration, for example, upon the initial startup of the Coriolis measurement device.

The increase in the oscillation amplitude terminates upon the value falling below of the first threshold value and/or a third threshold value. The third threshold value can be determined similarly to the second threshold value. Upon the value falling below of a minimum variation, there may be a reason to reduce the signal amplitude back to a normal value.

The time period D or a number of measuring tube oscillations of a cycle of an increase in the oscillation amplitude is thereby preferably limited, wherein a correlation between a limitation B of the time period and the factor E of the increase is set up, for example, as follows: B is proportional to P1*E\hat{ }(−n) with n greater than or equal to 1 and P1 as the first proportionality factor. The person skilled in the art can also refer to literature, for example, in which a correlation between material stress and material fatigue is indicated. The person skilled in the art will find such information for example in ASME, Section VIII, Div. 2, Code Edition 2001, see for example Curve 110.2.1. The number of measuring tube oscillations is proportional to the time period D with an oscillation frequency as proportionality factor.

An overload of the measuring tube or of a coupler can be calculated, for example, based on a total time of increase in oscillation amplitude or number of measuring tube oscillations with increased oscillation amplitude over all cycles and based on the respective increase, wherein, for example, P2*E\hat{ }(n)*D is summed over products, wherein P2 is a second proportionality factor. In this way, overload failure of the at least one measuring tube can be avoided. Typically, checking scenarios or test scenarios last only a short time, such that a single check typically takes less time than the limitation B allows. Exhausting the limitation does not lead to measuring tube failure. In doing so, the proportionality factor P1 and/or E and/or P2 can be derived from material science knowledge, which is known for example from the literature specified above.

FIG. 3 outlines the sequence of an exemplary method according to the invention, wherein in a first method step 101 it is checked whether a measured value of one of the following test variables of the medium: flow velocity, mass flow, volume flow, exceeds the first threshold value G1, or whether the variation S of a measured value exceeds the second threshold value G2.

In a second method step 102, if the first threshold value and/or the second threshold value is exceeded, the oscillation amplitude SA of the measuring tube oscillations is increased by a factor E by boosting exciter performance.

In a third method step 103, the increase in the oscillation amplitude SA is terminated upon the value falling below of the first threshold value and/or a third threshold value G3 concerning the variation of the measurement signal.

### LIST OF REFERENCE SIGNS

1 Coriolis measurement device
10 Measuring tube
11 Exciter
12.1 First sensor
12.2 Second sensor
13 Coil device
13.1 Coil
14 Magnetic device
14.1 Magnet
15 Electronic measuring/operating circuit
16 Temperature sensor
60 Supporting element
77 Electronic measuring/operating circuit 80 Housing
100 Method
101 Method step
102 Method step
103 Method step
D Time period
G1 First threshold value
G2 Second threshold value
G3 Third threshold value
MS Measurement variable/measured value curve of the measurement variable
S Variation
SA Oscillation amplitude

1-10. (canceled)

11. A method for recognizing a calibration and operating a calibration mode of a Coriolis measurement device for measuring a mass flow and/or a density of a medium flowing through a tube,
wherein the Coriolis measurement device comprises:
at least one measuring tube for guiding a medium,
at least one exciter for exciting measuring tube oscillations,
at least one first sensor and in particular at least one second sensor for detecting measuring tube oscillations,
an electronic measuring/operating circuit for operating the exciter and for detecting and evaluating measurement signals from the sensors and for providing measured values of the mass flow and/or density,
wherein the method includes the following steps:
in a first method step, checking whether an amount of a measured value of at least one test variable exceeds a first threshold value G1 or a variation of measured values of a test variable exceeds a second threshold value G2,
and increasing an oscillation amplitude of the measuring tube oscillations by a factor E by boosting exciter performance in a second method step when a threshold value is exceeded,
wherein the test variable is based on the following variable:
flow velocity,
wherein the following applies for G1:
the flow velocity in the measuring tube is greater than 4 m/s,
wherein the following applies for G2:
the variation of flow velocity in the measuring tube is in a time interval of at least 0.5 seconds,
greater than 150% of a reference value.

12. The method according to claim 11,
wherein E is at least 1.1
and/or wherein
E is at most 4.

13. The method according to claim 11,
wherein a time period or a number of measuring tube oscillations of one cycle of an increase in the oscillation amplitude is limited.

14. The method according to claim 13,
wherein an overload is calculated based on a total time of the increase in oscillation amplitude or a number of measuring tube oscillations with increased oscillation amplitude over all cycles and based on the respective increase.

15. The method according to claim 14,
wherein if the overload exceeds a threshold value, a warning message is output.

16. The method according to claim 11,
wherein the increase in the oscillation amplitude is terminated upon the value falling below of the first threshold value and/or a third threshold value concerning the variation of the measurement signal in a third method step.

17. The method according to claim 11,
wherein E is dependent on a measure of the exceeding of the first threshold value and/or second threshold value.

18. The method according to claim 11,
wherein a message is output as soon as the increase in the oscillation amplitude is reduced.

19. The method according to claim 11,
wherein the exciter along with the sensors in each case have a coil device with at least one coil and in each case have a magnetic device with at least one magnet.

20. The method according to claim 11,
wherein the reference value is stored in the electronic measuring/operating circuit and is determined by a calibration upon the first-time startup of the Coriolis measurement device.
